(19) United States
(12) Patent Application Publication
(10) Pub. No.: US 2025/0251675 A1
(43) Pub. Date: Aug. 7, 2025

(54) IMAGE FORMING APPARATUS THAT EXPOSES PHOTOSENSITIVE BODY USING PLURALITY OF LIGHT-EMITTING ELEMENTS

(71) Applicant: CANON KABUSHIKI KAISHA, Tokyo (JP)

(72) Inventors: ISAMI ITOH, Kanagawa (JP); KATSUYA NOSE, Chiba (JP); TAKESHI FUJINO, Chiba (JP)

(21) Appl. No.: 19/041,415

(22) Filed: Jan. 30, 2025

(30) Foreign Application Priority Data
Feb. 2, 2024 (JP) 2024-015051

(51) Int. Cl. G03G 15/041; G03G 15/00; G03G 15/04; G03G 21/08; G06K 15/02

(52) U.S. Cl. CPC G03G 15/0415; G03G 15/04036; G03G 15/5041; G03G 15/5058; G03G 21/08; G06K 15/1848; G06K 15/1894

(57) ABSTRACT

An image forming apparatus includes: a setting unit configured to set an exposure luminance; and a processing unit configured to generate first image data, which is a set of bit data for controlling emission or non-emission of light-emitting elements of a exposure head, and second image data, which is obtained by increasing/decreasing light-emitting elements that emit light in the first image data. The processing unit is configured to generate the second image data by increasing/decreasing, in a first region, which excludes an edge region inside a region in which pieces of bit data indicating emission are contiguous in the first image data, bit data indicating emission, according to a ratio of a setting value of the exposure luminance and a reference value of the exposure luminance.

### BACKGROUND OF THE INVENTION

### Field of the Invention

The present invention relates to a technique for exposure in an image forming apparatus.

### Description of the Related Art

Electrophotographic image forming apparatuses form an electrostatic latent image on a rotationally driven photosensitive body by exposing the photosensitive body and form an image by developing the electrostatic latent image using developer, such as toner. For exposure of a photosensitive body, the image forming apparatuses include, for example, an exposure device that moves a spot of laser light on a photosensitive body in a direction parallel to the rotational axis of the photosensitive body. A direction of the rotational axis (rotational axis direction) of the photosensitive body is referred to as a main scanning direction. In such an exposure device, a polygon mirror for moving a spot of laser light in the main scanning direction on a photosensitive body, a motor for driving the polygon mirror, and the like are necessary. In contrast, Japanese Patent Laid-Open No. 2015-112856 and US-2018-0309890 disclose an image forming apparatus that exposes a photosensitive body using an exposure head that includes a plurality of light-emitting elements arranged along the main scanning direction. By using such an exposure head, a polygon mirror, a motor, and the like become unnecessary, and image forming apparatuses can be reduced in size.

As the plurality of light-emitting elements of the exposure head, light-emitting diodes (LEDs) or organic electroluminescence (EL), for example, may be used. However, when light-emitting elements with a relatively low exposure luminance (exposure intensity), such as LEDs and organic EL, are used for an exposure head, an exposure time per pixel needs to be increased. As an example, a time over which one pixel is exposed to laser light is 10 ns or less, whereas with organic EL, an exposure time of 10 us or more is necessary. Here, assuming that an integrated value of exposure luminance over an exposure time is defined as an exposure amount, if the exposure luminance is different, even if the exposure amount is the same, the potential of a photosensitive body after exposure will not be the same. Specifically, as the exposure luminance decreases, the linearity of a relationship between the exposure amount and the potential of the photosensitive body after exposure increases. As the linearity increases, contrast in an image region with a low exposure amount, such as a highlight region and a thin line, decreases, and reproducibility of an image decreases.

### SUMMARY OF THE INVENTION

According to an aspect of the present disclosure, an image forming apparatus includes: a photosensitive body configured to be rotationally driven; an exposure head configured to expose the photosensitive body, using a plurality of light-emitting elements arranged along a direction of a rotational axis of the photosensitive body; a setting unit configured to set an exposure luminance of the photosensitive body by the plurality of light-emitting elements; and a processing unit configured to generate first image data, which is a set of bit data for controlling emission or non-emission of the plurality of the light-emitting elements, and based on the first image data, second image data, which is obtained by increasing or decreasing light-emitting elements that emit light in the first image data, and perform processing for outputting the second image data to the exposure head, wherein the processing unit is configured to generate the second image data by increasing/decreasing, in a first region, which excludes an edge region inside a region in which pieces of bit data indicating emission of a light-emitting element are contiguous in the first image data, bit data indicating emission of a light-emitting element, according to a ratio of a setting value of the exposure luminance set in the setting unit and a reference value of the exposure luminance.

Further features of the present invention will become apparent from the following description of exemplary embodiments with reference to the attached drawings.

### BRIEF DESCRIPTION OF THE DRAWINGS

FIG. 1 is a diagram of a schematic configuration of an image forming apparatus according to some embodiments.

FIGS. 2A and 2B are diagrams for explaining a configuration of an exposure head according to some embodiments.

FIGS. 3A and 3B are diagrams for explaining a configuration of a printed circuit board of the exposure head according to some embodiments.

FIG. 4 is a diagram for explaining light-emitting chips and light-emitting element arrays in the light-emitting chips according to some embodiments.

FIG. 5 is a plan view illustrating a schematic configuration of a light-emitting chip according to some embodiments.

FIG. 6 is a cross-sectional view illustrating a schematic configuration of a light-emitting chip according to some embodiments.

FIG. 7 is a diagram for explaining multiple exposures by light-emitting elements arranged in a step manner.

FIG. 8 is a diagram of a schematic configuration for controlling an image forming apparatus according to some embodiments.

FIG. 9 is a circuit diagram illustrating a configuration for controlling the exposure head according to some embodiments.

FIG. 10 is a signal chart related to access to a register of a light-emitting chip according to some embodiments.

FIG. 11 is a signal chart related to transmission of image data to a light-emitting chip according to some embodiments.

FIG. 12 is a functional block diagram illustrating a detailed configuration of a light-emitting chip according to some embodiments.

FIG. 13 is a diagram illustrating an example of a relationship between a line width in input image data and a line width in an output image.

FIG. 14 is a flowchart of processing for generating image data to be outputted to an exposure head according to some embodiments.

FIGS. 15A to 15C are diagrams illustrating examples of an edge preserving filter.

FIG. 16A is a diagram illustrating an example of an LUT.

FIG. 16B is a diagram illustrating an example of an error diffusion filter.

FIGS. 17A to 17D are diagrams for explaining processing in the flowchart indicated in FIG. 14.

FIG. 18 is a flowchart of processing for determining the amount of increase in exposure luminance according to one embodiment.

FIG. 19 is a flowchart of processing for determining the amount of increase in exposure luminance according to one embodiment.

FIG. 20 is a flowchart of discharge processing according to some embodiments.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

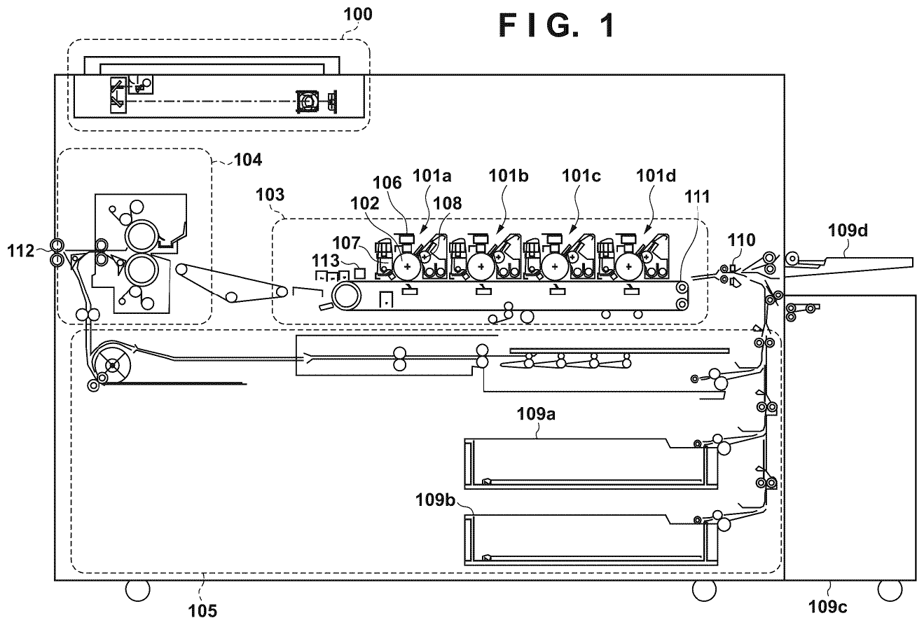

FIG. 1 is a diagram illustrating an example of a schematic configuration of an image forming apparatus 1 according to the present embodiment. A reading unit 100 optically reads a document placed on a document table and generates read image data. An image creation unit 103 forms an image on a sheet based on, for example, read image data generated by the reading unit 100 or print image data received from an external apparatus via a network. The image creation unit 103 includes image forming units 101a, 101b, 101c and 101d. The image forming units 101a, 101b, 101c and 101d respectively form black, yellow, magenta, and cyan toner images. The image forming units 101a, 101b, 101c and 101d are similar in their configurations and will be collectively referred to as the image forming units 101 below. A photosensitive body 102 of the image forming unit 101 is rotationally driven in a clockwise direction in the figure at the time of image formation. A charging device 107 charges the photosensitive body 102. An exposure head 106 exposes the photosensitive body 102 to form an electrostatic latent image on the surface of the photosensitive body 102. A developing device 108 develops the electrostatic latent image on the photosensitive body 102 with toner to form a toner image on the photosensitive body 102. The toner image formed on the photosensitive body 102 is transferred to a sheet conveyed on a transfer belt 111. By transferring the toner images of four photosensitive bodies 102 onto a sheet in a superimposed manner, a color image including four color components, which are black, yellow, magenta, and cyan, can be formed.

A conveyance unit 105 controls sheet feeding and conveyance. Specifically, the conveyance unit 105 feeds a sheet from a designated unit among internal storage units 109a and 109b, an external storage unit 109c, and a manual feeding unit 109d to a conveyance path of the image forming apparatus 1. The fed sheet is conveyed to registration rollers 110. The registration rollers 110 convey the sheet onto the transfer belt 111 at an appropriate timing such that the toner images of respective photosensitive bodies 102 are transferred to the sheet. As described above, the toner images are transferred to the sheet while the sheet is being conveyed on the transfer belt 111. A fixing unit 104 fixes the toner images onto the sheet by heating and pressing the sheet to which the toner images have been transferred. After the toner images have been fixed, the sheet is discharged to the outside of the image forming apparatus 1 by discharging rollers 112. An optical sensor 113 is arranged at a position facing the transfer belt 111. The optical sensor 113 optically reads a test chart formed on the transfer belt 111 by the image forming units 101. A result of reading the test chart by the optical sensor 113 is used, for example, for controlling correction of positional shift, density, and the like.

Although an example in which toner images are directly transferred from the respective photosensitive bodies 102 to a sheet on the transfer belt 111 has been described here, toner images may be indirectly transferred to a sheet from the respective photosensitive bodies 102 via an intermediate transfer member. Further, although an example in which a color image is formed using a plurality of colors of toner has been described here, a technique according to the present disclosure is also applicable to an image forming apparatus that forms a monochrome image using a single color of toner.

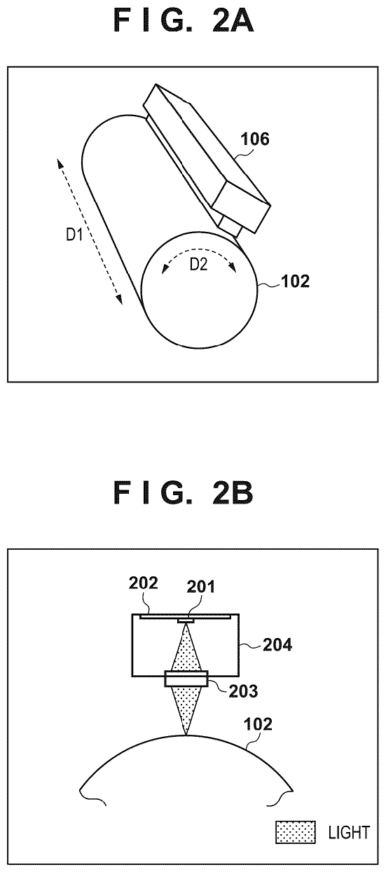

FIGS. 2A and 2B indicate the photosensitive body 102 and the exposure head 106. The exposure head 106 includes a light-emitting element array 201, a printed circuit board 202 on which the light-emitting element array 201 is mounted, a rod lens array 203, and a housing 204 holding the rod lens array 203 and the printed circuit board 202. The photosensitive body 102 has a cylindrical shape. The exposure head 106 is arranged such that its lengthwise direction is parallel to a direction D1 (hereinafter, referred to as an axial direction) of the rotational axis of the photosensitive body 102 and a surface on which the rod lens array 203 is attached faces the surface of the photosensitive body 102. While the photosensitive body 102 is rotating in a circumferential direction D2, the light-emitting element array 201 of the exposure head 106 emits light, and the rod lens array 203 focuses that light onto the surface of the photosensitive body 102.

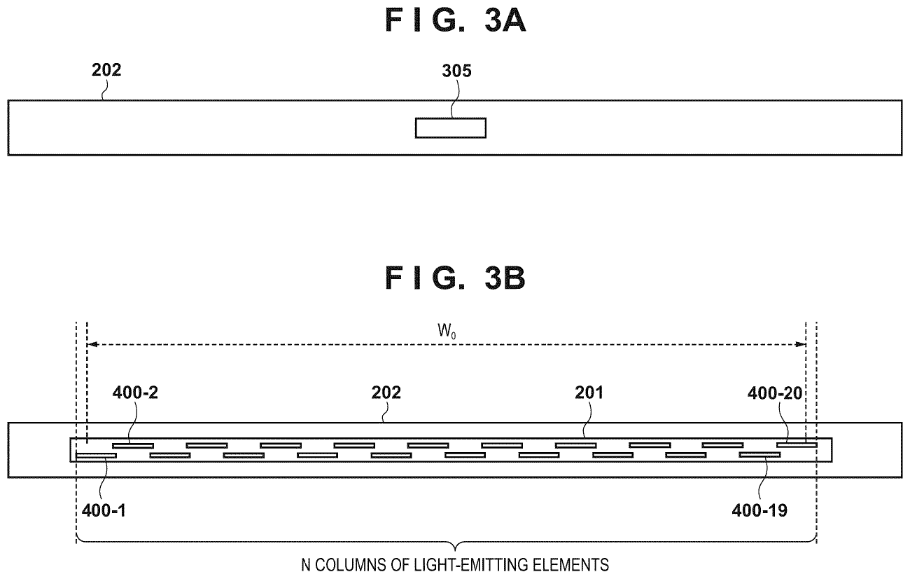

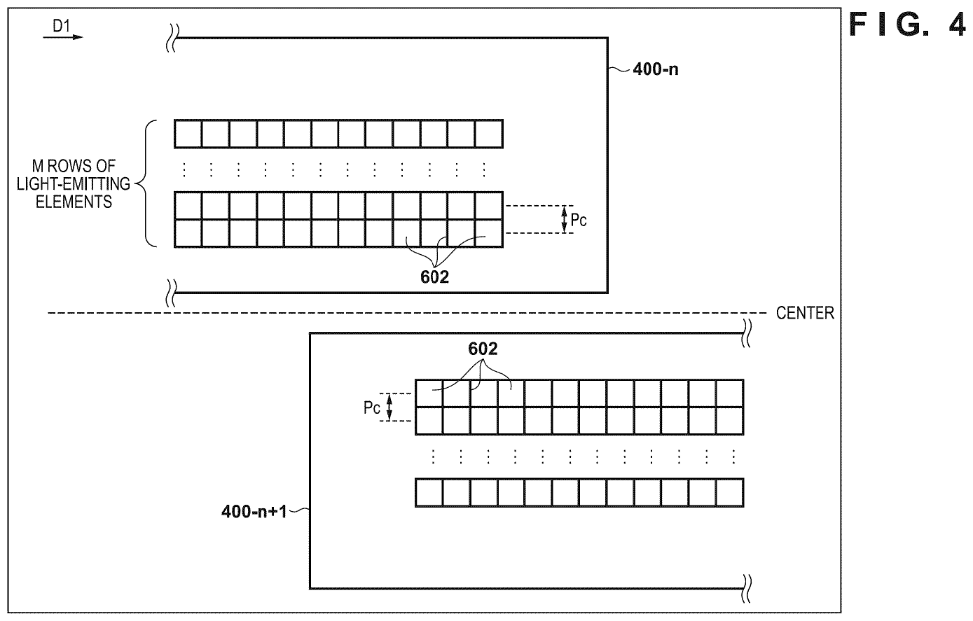

FIGS. 3A and 3B illustrate an example of a configuration of the printed circuit board 202. FIG. 3A illustrates a surface on which a connector 305 is mounted, and FIG. 3B illustrates a surface (surface opposite to the surface on which the connector 305 is mounted) on which the light-emitting element array 201 is mounted. FIG. 4 is a diagram schematically illustrating arrangement of light-emitting chips 400 and light-emitting elements 602 in the light-emitting chips 400.

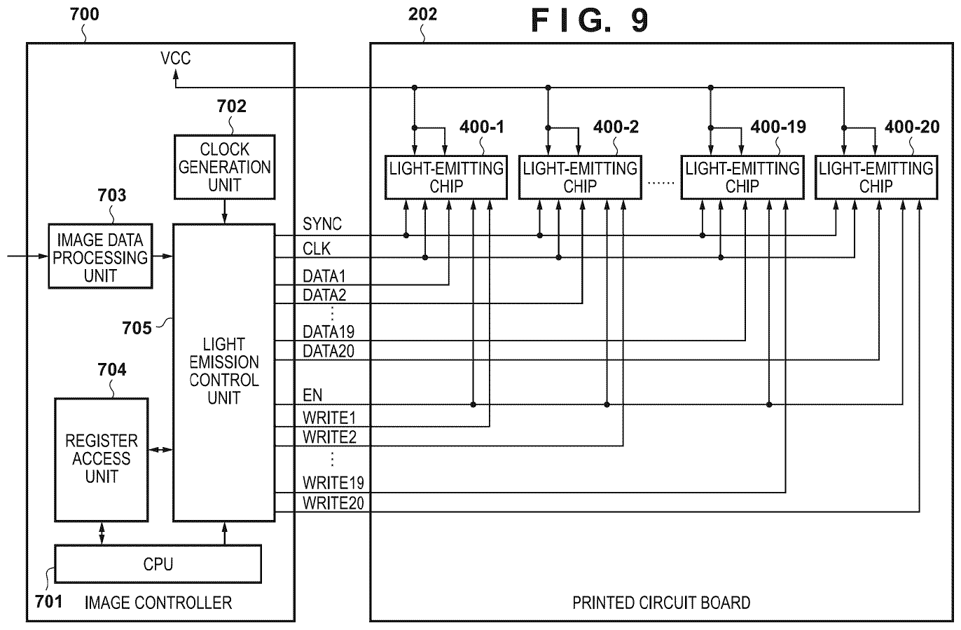

In the present embodiment, the light-emitting element array 201 includes a plurality of light-emitting elements that have been arranged two-dimensionally. The light-emitting element array 201 includes a total of N columns of light-emitting elements in the axial direction D1 of the photosensitive body and M rows of light-emitting elements in the circumferential direction D2 of the photosensitive body, where M and N are integers greater than or equal to 2. In the example of FIG. 3B, the light-emitting element array 201 is constituted by being separated into 20 light-emitting chips 400-1 to 400-20, each including a subset of all of the plurality of light-emitting elements, and the light-emitting chips 400-1 to 400-20 are arranged in a staggered manner along the axial direction D1. The light-emitting chips 400-1 to 400-20 are also collectively referred to as the light-emitting chips 400. As illustrated in FIG. 3B, a range occupied by all of the light-emitting elements of 20 light-emitting chips in the axial direction D1 is wider than a range occupied by a maximum width W0 of input image data. Therefore, some light-emitting elements positioned at either end in the axial direction D1 need not be used to expose the photosensitive body 102 unless positional shift of an image is detected. The respective light-emitting chips 400 of the printed circuit board 202 are connected to an image controller 700 (FIG. 9) via the connector 305. In the following, for the sake of descriptive convenience, those on a smaller sub-number side may be referred to as being on the “left” and those on a larger sub-number side may be referred to as being on the “right” among the light-emitting chips 400-1 to 400-20 arranged along the axial direction D1. For example, the light-emitting chip 400-1 is the leftmost light-emitting chip 400 and the light-emitting chip 400-20 is the rightmost light-emitting chip.

A number J (J=N/20) of light-emitting elements 602 arranged in each row of one light-emitting chip 400 may be equal to, for example, 748 (J=748). Meanwhile, the number M of light-emitting elements 602 arranged in each column of one light-emitting chip 400 may be equal to, for example, 4 (M=4). That is, in an exemplary embodiment, each light-emitting chip 400 includes a total of 2992 (=748×4) light-emitting elements 602, with 748 light-emitting elements 602 in the axial direction D1 and four light-emitting elements 602 in the circumferential direction D2. A spacing P_{C} between the central points of the light-emitting elements 602 that are adjacent in the circumferential direction D2 may be, for example, about 21.16 μm, which corresponds to a resolution of 1200 dpi. A spacing between the central points of the light-emitting elements 602 that are adjacent in the axial direction D1 may also be about 21.16 μm, in which case, 748 light-emitting elements 602 occupy a length of about 15.8 mm in the axial direction D1. For the sake of descriptive convenience, FIG. 4 illustrates an example in which the light-emitting elements 602 are arranged in a grid manner in each light-emitting chip 400. However, M light-emitting elements 602 in each column (M=4) can be arranged in a step manner.

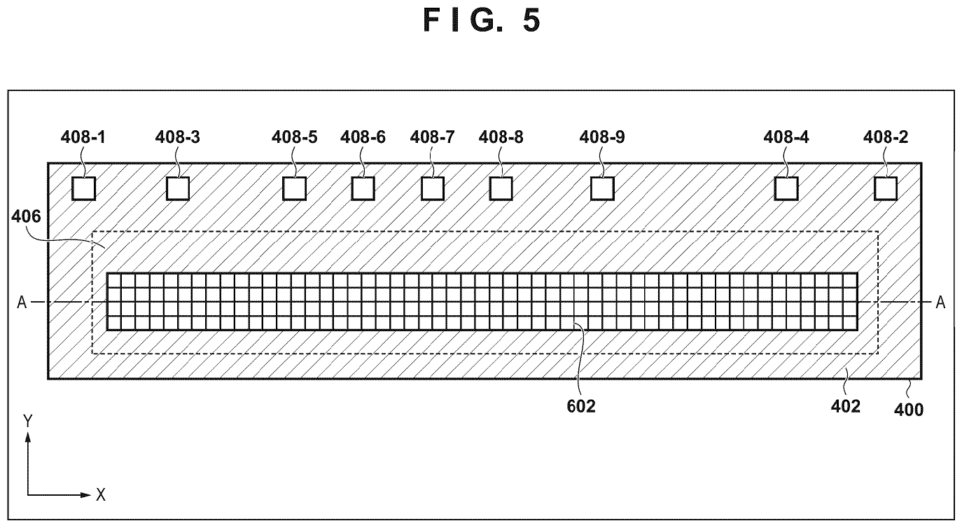

FIG. 5 is a plan view illustrating a schematic configuration of the light-emitting chip 400. A plurality of light-emitting elements 602 of each light-emitting chip 400 are formed on a light-emitting substrate 402, which is a silicon substrate, for example. Further, a circuit unit 406 for driving the plurality of light-emitting elements 602 is provided on the light-emitting substrate 402. Signal lines for communicating with the image controller 700, power supply lines for connecting to a power source, and ground lines for connecting to ground are connected to pads 408-1 to 408-9. The signal lines, the power supply lines, and the ground lines may, for example, be wires made of gold.

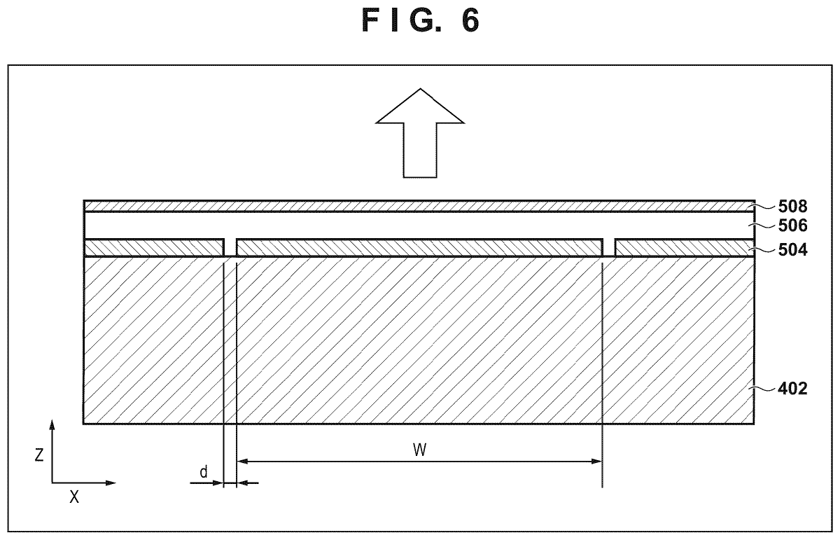

FIG. 6 illustrates a portion of a cross section along line A-A of FIG. 5. A plurality of lower electrodes 504 are formed on the light-emitting substrate 402. A gap of a length d is provided between two adjacent lower electrodes 504. A light-emitting layer 506 is provided on the lower electrodes 504, and an upper electrode 508 is provided on the light-emitting layer 506. The upper electrode 508 is one common electrode for the plurality of lower electrodes 504. When a voltage is applied between the lower electrode 504 and the upper electrode 508, a current flows from the lower electrode 504 to the upper electrode 508, thereby causing the light-emitting layer 506 to emit light. Therefore, one lower electrode 504 and a partial region of the light-emitting layer 506 and the upper electrode 508 corresponding to that lower electrode 504 constitute one light-emitting element 602. That is, in the present embodiment, the light-emitting substrate 402 includes a plurality of light-emitting elements 602.

An organic EL film, for example, may be used for the light-emitting layer 506. The upper electrode 508 is constituted by a transparent electrode, such as indium tin oxide (ITO), for example, so as to transmit the emission wavelengths of the light-emitting layer 506. Although in the present embodiment the entire upper electrode 508 transmits the emission wavelengths of the light-emitting layer 506, the entire upper electrode 508 need not transmit the emission wavelengths. Specifically, partial regions where light from the respective light-emitting elements 602 passes need only transmit the emission wavelengths. Although in FIG. 6 one continuous light-emitting layer 506 is formed, a plurality of light-emitting layers 506, each having a width equivalent to a width W of the lower electrode 504, may be respectively formed on the lower electrodes 504. Further, although in FIG. 6 the upper electrode 508 is one common electrode for the plurality of lower electrodes 504, a plurality of upper electrodes 508, each having a width equivalent to the width W of the lower electrode 504, may be formed corresponding to the respective lower electrodes 504. Further, among the lower electrodes 504 of each light-emitting chip 400, a first plurality of lower electrodes 504 may be covered by a first light-emitting layer 506, and a second plurality of lower electrodes 504 may be covered by a second light-emitting layer 506. Further, a first upper electrode 508 may be formed in common so as to correspond to the first plurality of lower electrodes 504 among the lower electrode 504 of each light-emitting chip 400, and a second upper electrode 508 may be formed in common so as to correspond to the second plurality of lower electrodes 504. Also in such configurations, one lower electrode 504 and a region of the light-emitting layer 506 and the upper electrode 508 corresponding to that lower electrode 504 constitute one light-emitting element 602.

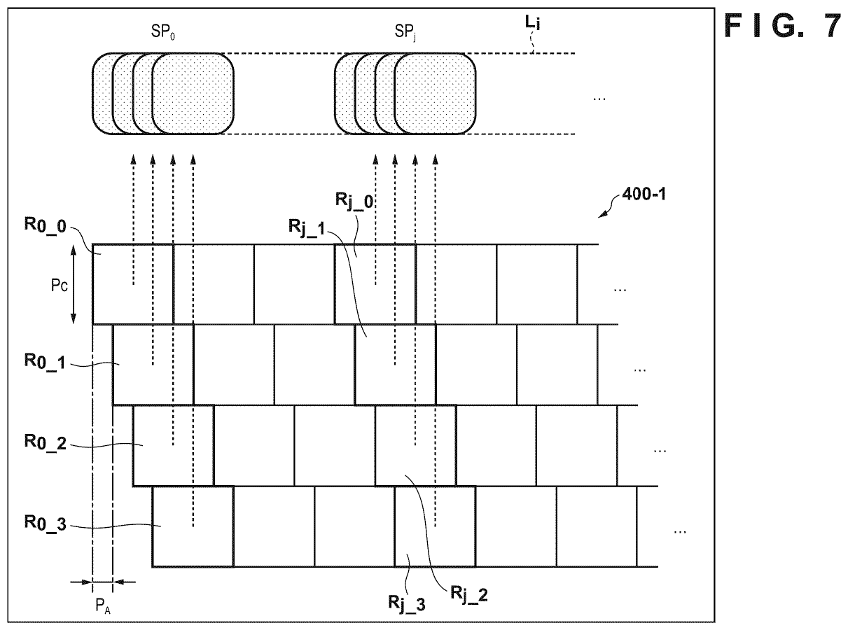

Although FIG. 4 illustrates an example in which the light-emitting elements 602 are arranged in a grid manner in each light-emitting chip 400, M light-emitting elements 602 in each column can be arranged a step manner at a constant pitch. FIG. 7 is a diagram for explaining multiple exposures by the light-emitting elements 602 arranged in a step manner. R_{j_m} in the figure represents the light-emitting element 602 of a j-th column from the left in the axial direction D1 and an m-th row from the top in the circumferential direction. In this example, j is an integer from 0 to 747, and m is an integer from 0 to 3. A circumferential pitch P_{C} of the light-emitting element 602 may be about 21.16 μm as described above. An axial spacing between two adjacent light-emitting elements 602 of the M light-emitting elements 602 of each column, that is, an axial pitch P_{A} of the light-emitting elements 602, may be about 5 μm, which corresponds to a resolution of 4800 dpi.

By four light-emitting elements 602 of each column thus being arranged in a step manner, any two adjacent light-emitting elements 602 among the four light-emitting elements 602 occupy a range partially overlapping in the axial direction. Then, while the photosensitive body 102 is rotating, one 1200-dpi pixel is exposed by four light-emitting elements 602 being caused to sequentially emit light corresponding to a respective pixel position of input image data that is, for example, 1200 dpi in resolution. When input image data is 2400 dpi, one 2400-dpi pixel is exposed by two light-emitting elements 602 being caused to sequentially emit light. In the following description, a region of the photosensitive body 102 exposed by one light-emitting element 602 will be referred to as a “dot”.

In the example of FIG. 7, when the leftmost pixel value of an i-th line of input image data indicates light emission on, light-emitting elements R_{0_0}, R_{0_1}, R_{0_2}, and R_{0_3} each are caused to emit light at a timing at which they face a line Lᵢ on the surface of the photosensitive body 102. As a result, a region corresponding to the leftmost pixel of the line Lᵢ is exposed in an overlapping manner to form a spot SP₀ corresponding to the leftmost pixel. Similarly, when a j-th pixel value from the left of the i-th line of the input image data indicates light emission on, light-emitting elements R_{j_0}, R_{j_1}, R_{j_2}, and R_{j_3} each are caused to emit light at a timing at which they face the line Lᵢ on the surface of the photosensitive body 102. As a result, a region corresponding to the j-th pixel from the left of the line Lᵢ is exposed in an overlapping manner to form a spot SPⱼ corresponding to the j-th pixel from the left.

As understood from FIG. 7, four light-emitting elements 602 in each column of the light-emitting chip 400 may be caused to emit light at appropriate timings to form, on the surface of the photosensitive body 102, a smooth line of an electrostatic latent image constituted by a series of spots having constant spot spacing and partially overlapping each other. Then, as a result of such lines being consecutively formed in the circumferential direction, a two-dimensional electrostatic latent image is formed.

Although specific numerical values for the sake of descriptive convenience are used in the present disclosure, these specific numerical values are illustrative, and the present invention is not limited to the specific numerical values used in the embodiments. Specifically, the number of light-emitting chips provided on one printed circuit board is not limited to 20 and can be any number that is one or more. Further, the light-emitting elements provided in each light-emitting chip 400 are not limited to being arranged in four rows and 748 columns and may be in other number of rows and number of columns. The circumferential and axial pitches of the light-emitting elements are not limited to about 21.16 μm and about 5 μm and may be any other values.

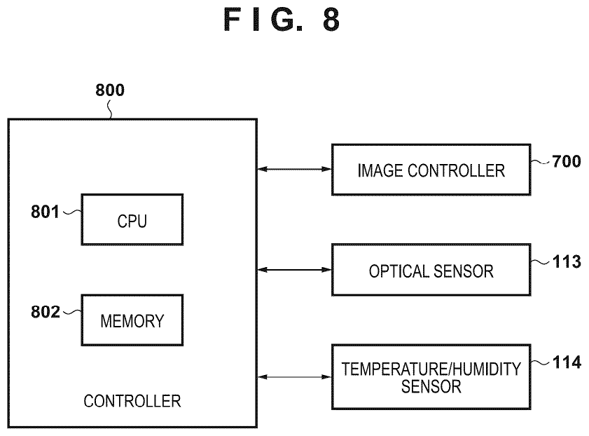

FIG. 8 illustrates a configuration for controlling the image forming apparatus. A controller 800 includes a CPU 801 and a memory 802. The CPU 801 includes one or more processors. The memory 802 is a generic term for a non-volatile memory device and a volatile memory device and stores control programs to be executed by the CPU 801 and control data to be used by the CPU 801 to control the image forming apparatus. The controller 800 outputs image data to the image controller 700 at the time of image formation. The image controller 700 will be described later in detail with reference to FIG. 9. The controller 800 obtains a result of reading a test chart formed on the transfer belt 111 from the optical sensor 113 when executing control for correcting positional shift, density, and the like. A temperature/humidity sensor 114 detects the environmental temperature and humidity of an environment in which the image forming apparatus is installed and notifies the controller 800 of a detection result as environmental information.

FIG. 9 illustrates a configuration for controlling the exposure head 106. The image controller 700 is a control circuit that communicates with the printed circuit board 202 via a plurality of signal lines (wires). A light emission control unit 705 terminates the signal lines to and from the printed circuit board 202. An n-th light-emitting chip 400-n on the printed circuit board 202 (n is an integer from 1 to 20) is connected to the light emission control unit 705 via a signal line DATAn and a signal line WRITEn. The signal line DATAn is used to transmit image data from the image controller 700 to the light-emitting chip 400-n. The signal line WRITEn is used by the image controller 700 to write control data to a register of the light-emitting chip 400-n.

One signal line CLK, one signal line SYNC, and one signal line EN are further provided between the light emission control unit 705 and the respective light-emitting chips 400. The signal line CLK is used to transmit a clock signal for transmission of data on the signal lines DATAn and WRITEn. The light emission control unit 705 outputs a clock signal generated based on a reference clock signal from a clock generation unit 702 to the signal line CLK. Signals transmitted to the signal line SYNC and the signal line EN will be described later.

An image data processing unit 703 performs image processing on image data received from the controller 800 to generate image data in a binary bitmap format for controlling on/off of light emission of the light-emitting elements 602 of the light-emitting chips 400 on the printed circuit board 202. The image processing here may include, for example, raster conversion, tone correction, color conversion, and halftone processing. The image data processing unit 703 performs thinning processing, which will be described later, on image data (first image data) that has been subjected to halftone processing and transmits image data (second image data) that has been subjected to thinning processing to the light emission control unit 705. A register access unit 704 receives, from a CPU 701, control data to be written in a register of each light-emitting chip 400 and transmits the control data to the light emission control unit 705. The control data includes a setting value of emission luminance (exposure luminance) of each light-emitting element 602 of each light-emitting chip 400. The setting value can, for example, be indicated by a value of a driving current to be supplied to each light-emitting element 602 or a value of a driving voltage for supplying that driving current to obtain a target exposure luminance.

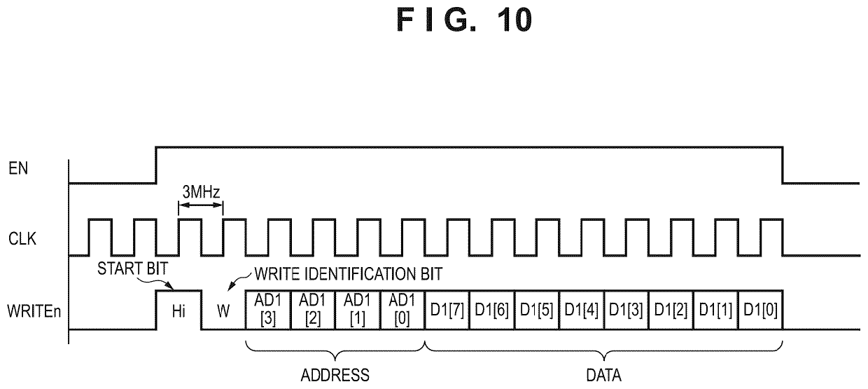

FIG. 10 illustrates transition of signal levels of respective signal lines for when control data is written in the register of the light-emitting chip 400. An enable signal indicating that communication is in progress by assuming a high level during communication is outputted to the signal line EN. The light emission control unit 705 transmits a start bit to the signal line WRITEn in synchronization with a rise of the enable signal. Next, the light emission control unit 705 transmits a write identification bit indicating that it is a write operation and then transmits an address (4 bits in this example) of the register in which the control data is to be written and control data (8 bits in this example). When writing to the register, the light emission control unit 705 sets the frequency of the clock signal to be transmitted to the signal line CLK to be, for example, 3 MHz.

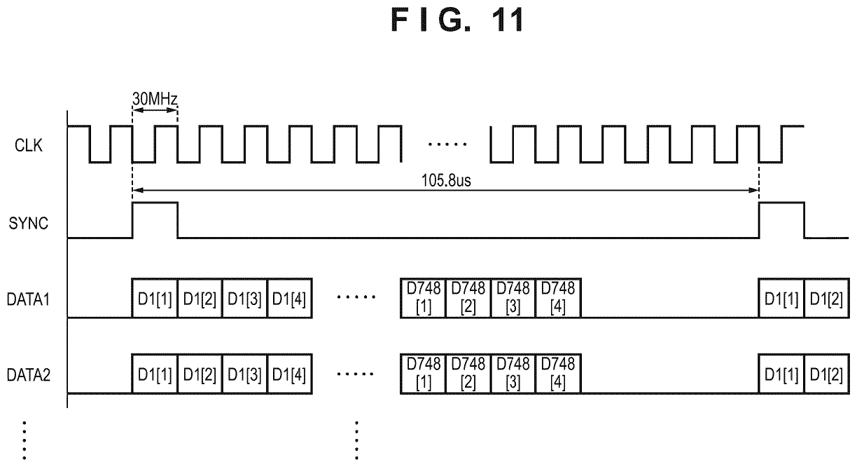

FIG. 11 illustrates transition of signal levels of respective signal lines for when image data is transmitted to the respective light-emitting chips 400. A periodic line synchronization signal indicating an exposure timing of a respective line on the photosensitive body 102 is outputted to the signal line SYNC. Assuming that a circumferential velocity of the photosensitive body 102 is 200 mm/s and a circumferential resolution is 1200 dpi (about 21.16 μm), the line synchronization signal is outputted at a period of about 105.8 μs. The light emission control unit 705 transmits image data to signal lines DATA1 to DATA20 in synchronization with a rise of the line synchronization signal. In the present embodiment, since each light-emitting chip 400 includes 2992 light-emitting elements 602, it is necessary to transmit, to each light-emitting chip 400, image data indicating emission/non-emission of each of a total of 2992 light-emitting elements 602 within a period of about 105.8 μs. Therefore, in this example, as illustrated in FIG. 11, when transmitting image data, the light emission control unit 705 sets the frequency of the clock signal transmitted to the signal line CLK to 30 MHz.

FIG. 12 is a functional block diagram illustrating a detailed configuration of one light-emitting chip 400. As illustrated in FIG. 5, the light-emitting chip 400 includes nine pads 408-1 to 408-9. The pad 408-1 and the pad 408-2 are connected to a power supply voltage VCC by a power supply line. Power is supplied to respective circuits of the circuit unit 406 of the light-emitting chip 400 by the power supply voltage VCC. The pad 408-3 and the pads 408-4 are connected to ground by a ground line. Each circuit and the upper electrode 508 of the circuit unit 406 are connected to ground via the pad 408-3 and the pads 408-4. The signal line CLK is connected to a transfer unit 1003, a register 1102, and latch units 1004-001 to 1004-748 via the pad 408-5. The signal lines SYNC and DATAn are connected to the transfer unit 1003 via the pads 408-6 and 408-7. The signal lines EN and WRITEn are connected to the register 1102 via the pads 408-8 and 408-9. The register 1102 stores, for example, control data including data indicating the setting value for luminance of exposure by the light-emitting elements 602.

Triggered by the line synchronization signal from the signal line SYNC, the transfer unit 1003 receives, from the signal line DATAn, input image data (second image data) including a series of data values indicating emission or non-emission of each one of the light-emitting elements 602 in synchronization with the clock signal from the signal line CLK. The transfer unit 1003 performs, in units of M (e.g., M=4) data values, serial-parallel conversion on the series of data values serially received from the signal line DATAn. For example, the transfer unit 1003 includes four D flip-flops that are connected in a cascading manner and parallelizes data values DATA-1, DATA-2, DATA-3, and DATA-4, which have been inputted over four clocks, and outputs them to latch units 1004-0001 to 1004-748. The transfer unit 1003 further includes four D flip-flops for delaying the line synchronization signal and outputs a first latch signal to the latch unit 1004-001 via a signal line LAT1 at a timing that has been delayed by four clock cycles from when the line synchronization signal was inputted.

A k-th latch unit 1004-k (k is an integer from 1 to 748) holds, using a latch circuit, the four data values DATA-1, DATA-2, DATA-3, and DATA-4 inputted from the transfer unit 1003 simultaneously with input of a k-th latch signal. Further, except for the last-stage latch unit 1004-748, the k-th latch unit 1004-k outputs, to a latch unit 1004-(k+1), a (k+1)-th latch signal obtained by delaying the k-th latch signal by four clock cycles, via a signal line LAT (k+1). Then, during the signal period of the k-th latch signal, the k-th latch unit 1004-k continues to output, to a current driving unit 1104, a driving signal that is based on the four data values held by the latch circuit. For example, there is a delay of four clock cycles between a timing at which the first latch signal is inputted to a latch unit 1004-1 and a timing at which the second latch signal is inputted to the latch unit 1004-2. Therefore, whereas the latch unit 1004-1 outputs a driving signal that is based on the first, second, third and fourth data values to the current driving unit 1104, the latch unit 1004-2 outputs a driving signal that is based on the fifth, sixth, seventh and eighth data values to the current driving unit 1104. Generally speaking, the latch unit 1004-k outputs a drive signal that is based on (4k−3), (4k−2), (4k−1) and (4k)-th data values to the current driving unit 1104. Therefore, in the embodiment illustrated in FIG. 12, 748 latch units 1004-001 to 1004-748 outputs 2992 drive signals for controlling driving of 2992 (=748×4) light-emitting elements 602 in a substantially parallel manner to the current driving unit 1104. Each driving signal is a binary signal indicating a high level or low level.

The current driving unit 1104 includes 2992 light emission driving circuits respectively corresponding to 2992 light-emitting elements 602, each including a partial region of the light-emitting layer 506. While a corresponding driving signal indicates a high level meaning that light emission is on, a respective light emission driving circuit applies a driving voltage corresponding to an exposure luminance indicated by control data in the register 1102 to the light-emitting layer 506 of a corresponding light-emitting element 602. With this, a driving current flows to the light-emitting layer 506, and the light-emitting element 602 emits light. The control data may indicate one individual exposure intensity for each light-emitting element 602, one exposure intensity for each group of light-emitting elements 602, or one exposure intensity common to all light-emitting elements 602.

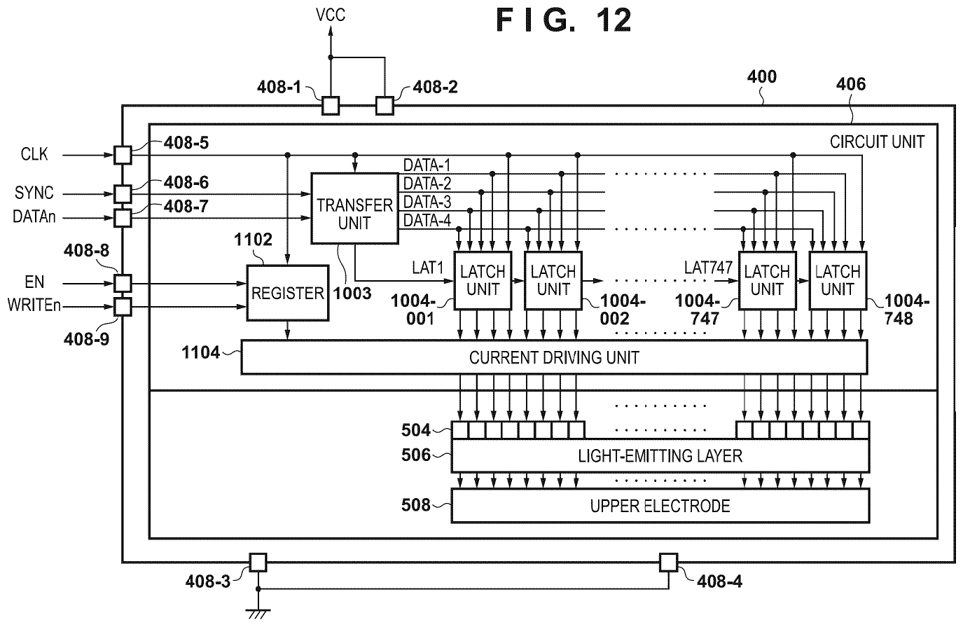

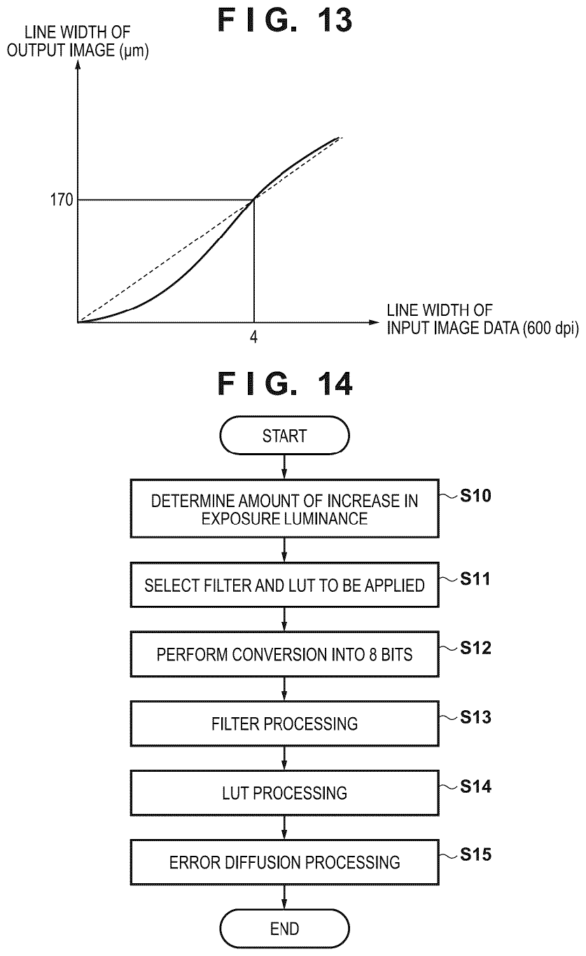

For example, when light-emitting elements having a low exposure luminance (exposure intensity) are used as in the exposure head 106 in the present embodiment, an exposure time for one pixel needs to be longer than when laser light is used, such as 10 μs or longer, in order to ensure a necessary exposure amount. In such a case, the linearity of a relationship between the exposure amount and the potential of the photosensitive body 102 after exposure increases. As the linearity increases, contrast in an image region with a low exposure amount, such as a highlight region and a thin line, decreases, and reproducibility of an image decreases. As an example, FIG. 13 illustrates a relationship between a line width indicated by input image data and a line width of an output image (image to be formed) for when organic EL is used as light-emitting elements. The horizontal axis of FIG. 13 illustrates a line width with the number of dots for a case where 600 dpi. A dot corresponds to a region of the photosensitive body 102 exposed by one light-emitting element 602. Since it is 600 dpi, the spacing between the dots is about 42.3 μm. The vertical axis of FIG. 13 indicates a line width of an output image in μm. As illustrated in FIG. 13, when a line width indicated by input image data is less than 4 dots (about 170 μm), a line width of an output image becomes narrower than the line width indicated by the input image data.

In the present embodiment, in order to improve reproducibility of a highlight region and a thin line, a setting value for an exposure luminance is increased from a reference value. A reference value for an exposure luminance is a luminance value with a maximum density as its target density. In the following description, an exposure luminance that has been set to a reference value is also referred to as a reference luminance. When an exposure luminance is increased from the reference luminance in order to improve reproducibility of a highlight region and a thin line, a region that is different from a highlight region and a line that is not a thin line become higher in density than their target densities. Therefore, in the present embodiment, regions in which the density becomes higher than their target density are controlled such that the densities of these regions approach their target densities by a portion of the plurality of light-emitting elements 602 for exposing that region being set from light emission (on) to non-light emission (off).

FIG. 14 is a flowchart of processing to be performed by the image forming apparatus. In step S10, the controller 800 determines an amount of increase in exposure luminance from a reference luminance. The amount of increase in exposure luminance may be, for example, a predetermined value. In this case, an amount of increase in exposure luminance is stored in advance in the memory 802. The amount of increase in exposure luminance can be determined based on the state of the photosensitive body 102.

For example, the film thickness of the photosensitive body 102 may decrease due to wearing of the surface of the photosensitive body 102 with image formation. When the film thickness of the photosensitive body 102 decreases, a distance between the surface of the photosensitive body 102 and a substrate, which has been set to a ground potential, decreases, and thus, an electric field intensity of an electrostatic latent image increases. Therefore, when the film thickness of the photosensitive body 102 decreases, reproducibility of a highlight increases. Therefore, a configuration may be taken so as to estimate the film thickness of the photosensitive body 102 and determine the amount of increase in exposure luminance based on the estimated film thickness of the photosensitive body 102. Specifically, a configuration may be taken so as to, as the estimated film thickness of the photosensitive body 102 decreases, reduce the amount of increase in exposure luminance. In this case, determination information indicating a relationship between the film thickness and the amount of increase in exposure luminance is stored in advance in the memory 802. The controller 800 can estimate the film thickness of the photosensitive body 102 based on a cumulative number of sheets on which an image has been formed using the photosensitive body 102 and a value of a discharge current during processing for charging the photosensitive body 102 by the charging device 107. The controller 800 notifies the image controller 700 of the determined amount of increase in exposure luminance.

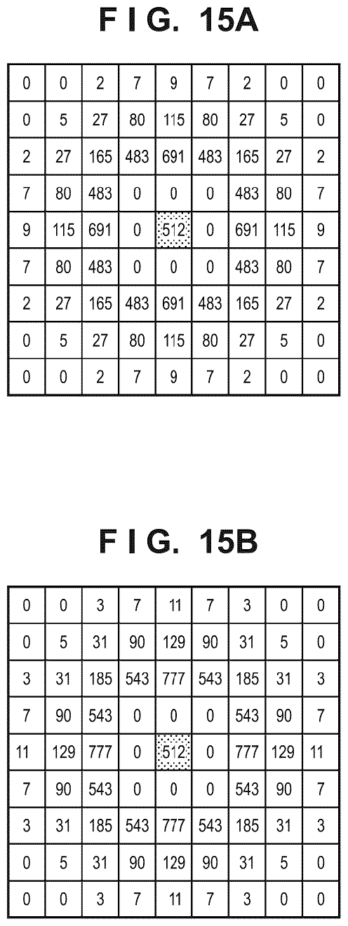

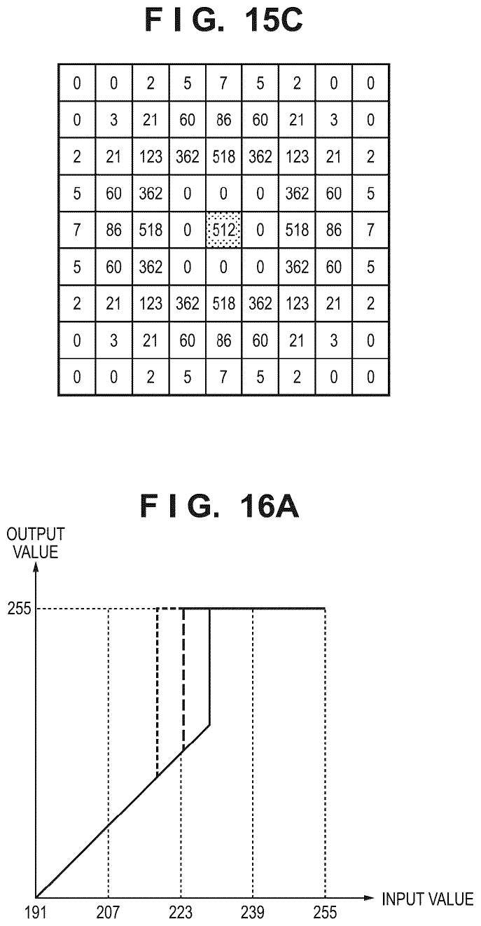

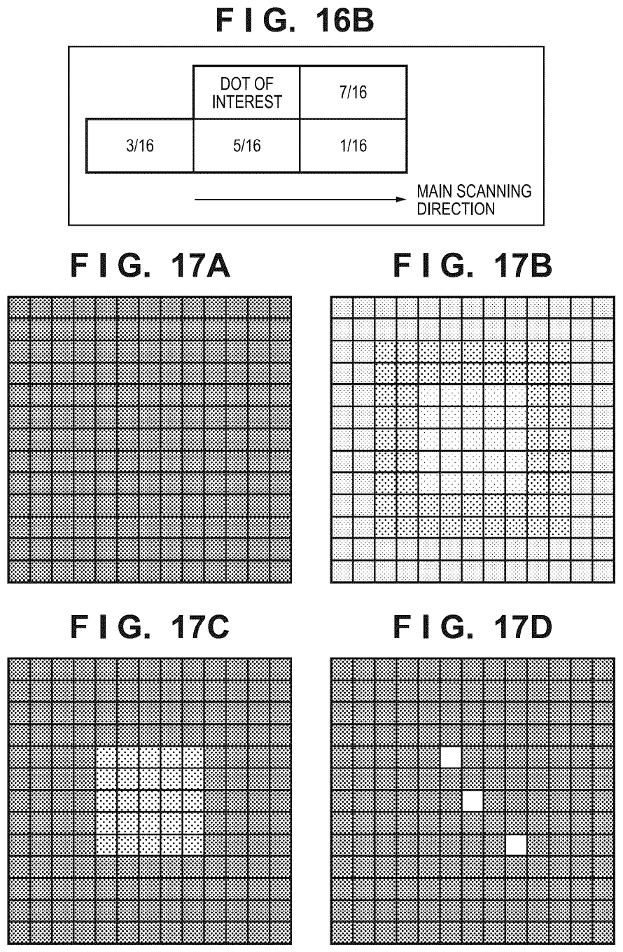

In step S11, the image controller 700 selects an edge preserving filter and an LUT to be applied based on the amount of increase in exposure luminance. FIGS. 15A, 15B, and 15C illustrate edge preserving filters to be used when the amount of increase in exposure luminance is 20%, 15%, and 10%, respectively. The values included in an edge preserving filter correspond to “dots” on the photosensitive body 102. The shaded dots in FIGS. 15A to 15C indicate dots of interest. For simplicity of the diagrams, the numerical values of the edge preserving filters in FIGS. 15A to 15C indicate an x portion of (x/1024). That is, in FIGS. 15A to 15C, although the values of the dots of interest are “512”, this means that the actual values are “512/1024”. The dotted, dashed, and solid lines in FIG. 16A indicate a relationship between input values and output values indicated by an LUT that is used when the amount of increase in exposure luminance is 20%, 15%, and 10%, respectively. In FIG. 16A, output values for when input values are 191 or greater are indicated, and output values for when input values are 191 or less are the same as the input values.

Returning to FIG. 14, the image data processing unit 703 of the image controller 700 performs thinning processing indicated in steps S12 to S15 on image data that has been subjected to dither processing. In the following description, image data that has been subjected to dither processing is referred to as first image data. The first image data is a set of binary bit data, each for controlling light emission (on) or non-light emission (off) of a corresponding light-emitting element 602. For example, the first image data indicates a value “1” when causing the light-emitting element 602 to emit light and indicates a value “0” when causing the light-emitting element 602 to not emit light. Further, as described above, a region of the photosensitive body 102 on which the light-emitting element 602 emits light is referred to as a “dot”. In this case, the first image data is data indicating whether to expose respective dots of the photosensitive body 102. In the following description, dots that are indicated to be exposed according to the first image data are referred to as exposure dots, and dots that are indicated to be not exposed according to the first image data are referred to as non-exposure dots. Therefore, the first image data is data indicating whether to form exposure dots on the photosensitive body 102 or form non-exposure dots by not forming exposure dots.

In step S12, the image data processing unit 703 converts the first image data into 8 bits. For example, the image data processing unit 703 converts a data value (e.g., a value “1”) representing an exposure dot into 255 and leaves a data value (e.g., a value “0”) representing a non-exposure dots as is at 0. In step S13, the image data processing unit 703 applies the edge preserving filter selected in step S11 to the first image data that has been converted into 8 bits. In step S14, the image data processing unit 703 converts, based on the LUT selected in step S11, the data values of the first image data that has been subjected to filter processing in which an edge preserving filter has been used. As is apparent from FIG. 16A, by use of the LUT, data values that are a threshold or greater are converted to a maximum value (255) and data value that are less than the threshold are left as is without being converted. The threshold varies depending on the LUT that is used.

In step S15, the image data processing unit 703 performs binarization processing, in which an error diffusion filter illustrated in FIG. 16B is used, on image data that has been converted using an LUT. Although details will be described later, dots to be subjected to an error diffusion filter are dots for which values have not been converted by the LUT among dots that are indicated as exposure dots by the first image data. In the following description, exposure dots, which are to be subjected to the error diffusion filter, are referred to as processing target dots. A portion of processing target dots is converted from being exposure dots to being non-exposure dots by binarization processing in which an error diffusion filter is used. The first image data that has been subjected to thinning processing indicated in steps S12 to S15 of FIG. 14 is outputted as the second image data to the exposure head 106. Although not illustrated in FIG. 14, the CPU 701 of the image controller 700 sets, in the register 1102 of each light-emitting chip 400, a setting value indicating an exposure luminance obtained by increasing the reference luminance by the amount of increase determined in step S10. The exposure head 106 exposes the photosensitive body 102 based on the second image data, using the exposure luminance obtained by increasing the reference luminance by the amount of increase determined in step S10.

FIGS. 17A to 17D are diagrams visually representing the thinning processing of steps S12 to S15 of FIG. 14. FIGS. 17A to 17D are schematic diagrams for facilitating understanding of thinning processing of steps S12 to S15 of FIG. 14 and do not illustrate actual processing in which the edge preserving filters illustrated in FIGS. 15A to 15C, the LUTs illustrated in FIG. 16A, and the error diffusion filter illustrated in FIG. 16B have been used. FIG. 17A illustrates exposure dots in the first image data. According to FIG. 17A, the entire 13-dot×13-dot region is exposure dots. Although not illustrated, all of the dots other than those in the 13-dot×13-dot region are assumed to be non-exposure dots.

The image data processing unit 703, in step S12, sets the data values of all the 13×13 dots illustrated in FIG. 17A to 255 and sets the data values of the other dots to 0 and, in step S13, applies an edge preserving filter. FIG. 17B illustrates the data values on which the edge preserving filter has been applied. In FIG. 17B, a lower density of shading indicates a smaller data value. Due to the edge preserving filter, the data values of the dots become smaller toward an inner portion of the 13-dot×13-dot region.

FIG. 17C illustrates a state in which the data values of the first image data, on which an edge preserving filter has been applied and which is illustrated in FIG. 17B, have been converted using an LUT. As illustrated in FIG. 16A, an LUT converts data values that are a threshold or greater to a maximum value (255) and leaves the other dots as they are. In FIG. 17C, the data values of a 4-dot wide peripheral portion in the 13-dot×13-dot region are converted to 255, and 5×5 dots in the inner portion thereof have the same values as in FIG. 17B. As described above, 5×5=25 dots in the inner portion of FIG. 17C become processing target dots.

FIG. 17D illustrates a state in which binarization processing, in which an error diffusion filter is used, is performed on the first image data, which has been converted by an LUT and is illustrated in FIG. 17C. In FIG. 17D, white dots indicate dots that have been converted into non-exposure dots among the 25 processing target dots. According to FIG. 17D, three dots out of 25 processing target dots have been converted into non-exposure dots.

An edge preserving filter and an LUT to be used when the amount of increase in exposure luminance is X % are designed such that about X % of the processing target dot become non-exposure dots. In addition, the edge preserving filter and the LUT are designed such that a Y-dot wide edge region in the periphery within a region where exposure dots are contiguous will not be a processing target dot. For example, in the example of FIGS. 17A to 17D, Y=4, and a 4-dot wide edge region in the periphery are not converted to non-exposure dots.

In the case of a small highlight region in a region where exposure dots are contiguous, all the exposure dots are included in the 4-dot wide edge region in the periphery. That is, none of the exposure dots in the highlight region will be processing target dots. Therefore, reproducibility of a highlight region increases. It is similar for a thin line that is thinner than a predetermined width. Meanwhile, in the case of a region different from a highlight region or a line having a predetermined width or more, among exposure dots excluding the 4-dot wide edge region in the periphery, exposure dots, the number of which corresponds to the amount (X %) of increase in exposure luminance, are converted into non-exposure dots. Thus, regarding a region different from a highlight region or a line having a predetermined width or more, it is possible to prevent an increase in density due to an increase in exposure luminance by X % from the reference luminance and bring the density closer to the target density.

As such, as the amount of increase in exposure luminance with respect to the reference luminance increases, the number of dots converted from exposure dots to non-exposure dots increases. More specifically, the greater the ratio of a setting value (exposure luminance) to the reference value (reference luminance), the greater the number of converted dots to the number of processing target dots. With this configuration, it is possible to improve reproducibility of a highlighted region and the like and to bring densities of other regions closer to the target density. The processing target dots are a region (first region) excluding an edge region within an exposure region, which is a region of the photosensitive body 102 and in which exposure dots are indicated to be contiguous by the first image data. In addition, a width Y of the edge region is predetermined and reflected in the design of edge preserving filters and LUTs.

In the present embodiment, dots to be converted from exposure dots to non-exposure dots are determined by binarization processing in which an error diffusion filter is used; however, dot dispersion type binarization processing, such as a blue noise mask method or an FM screen method, are also possible.

As described above, the second image data is generated by increasing or decreasing bit data indicating emission of light-emitting elements based on a ratio of the setting value to the reference value in the first region excluding the edge region within the region where the bit data indicating the emission of the light-emitting element 602 in the first image data is contiguous. With this configuration, it is possible to improve reproducibility of a highlighted region and the like and to bring densities of other regions closer to the target density.

### Second Embodiment

Next, a second embodiment will be described focusing on differences from the first embodiment. In the first embodiment, the exposure luminance is increased by X % from the reference luminance, and about X % of dots are converted from processing target dots into non-exposure dots. The reference luminance of the light-emitting element 602 is a luminance for setting the maximum density as the target density, and the maximum density depends on a latent image contrast Vc, which is a difference between a charging potential Vd of the photosensitive body 102 by the charging device 107 and an exposure potential VL of the photosensitive body 102 exposed by the exposure head 106. That is, the reference luminance is a luminance for setting the latent image contrast Vc as the target value. Here, the target value of the latent image contrast Vc needed to set the maximum density as the target density changes according to the installation environment of the image forming apparatus. Generally, the target value of the latent image contrast Vc needed to set the maximum density as the target density increases as a relative humidity RH inside the image forming apparatus 1 increases. In order to increase a value (absolute value) of the latent image contrast Vc, the reference luminance needs to be increased, and so, as the relative humidity RH inside the image forming apparatus 1 increases, the reference luminance needs to be increased. That is, the value of the reference luminance changes depending on the relative humidity RH inside the image forming apparatus 1.

Here, when thinning processing in which the exposure luminance is increased by X % from the reference luminance and about X % of dots of the processing target dots are converted into non-exposure dots is implemented by an integrated circuit, such as an ASIC, a limit may be provided for a range of exposure luminance according to the value of X. As an example, it is assumed that when the value of the amount X of increase in exposure luminance (=thinning amount of the processing target dots) is 10%, the light-emitting element 602 can be caused to emit light within a range from a first luminance value to a fourth luminance value, and when it is 15%, the light-emitting element 602 can be caused to emit light within a range from a second luminance value to a fifth luminance value, and when it is 20%, the light-emitting element 602 can be caused to emit light within a range from a third luminance value to a sixth luminance value. Here, it is assumed that luminance increases in order from the first luminance value to the sixth luminance value.

In such a case, when the exposure luminance in which the luminance value (reference luminance) for achieving the necessary latent image contrast Vc is increased by 20% is lower than the third luminance value due to the value of the relative humidity RH, the amount X of increase cannot be 20%. That is, the exposure luminance in which the luminance value (reference luminance) for achieving the necessary latent image contrast Vc has been increased by 20% needs to be within a scope from the third luminance value to the sixth luminance value. Similarly, when the exposure luminance in which the luminance value (reference luminance) for achieving the necessary latent image contrast Vc is increased by 10% may be greater than the fourth luminance value due to the value of the relative humidity RH, the amount X of increase cannot be 10%. That is, the exposure luminance in which the luminance value (reference luminance) for achieving the necessary latent image contrast Vc has been increased by 10% needs to be within a scope from the first luminance value to the fourth luminance value.

Therefore, in the present embodiment, the necessary latent image contrast Vc is determined based on environmental information, and the amount X of increase in exposure luminance is determined based on the determined latent image contrast Vc.

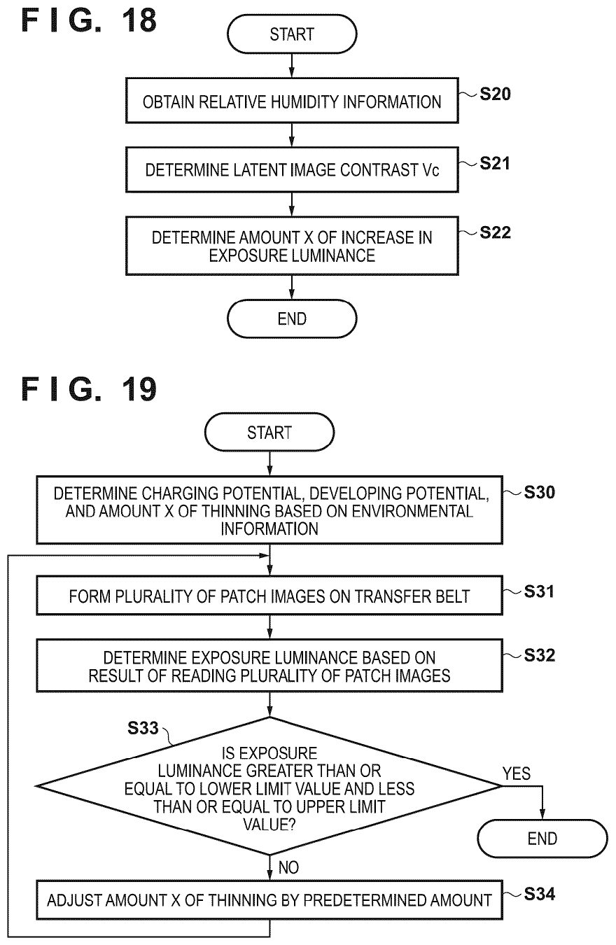

FIG. 18 is a flowchart of processing for determining the amount X of increase in exposure luminance according to the present embodiment. The processing of FIG. 18 corresponds to the processing performed in step S10 of FIG. 14 in the first embodiment. In step S20, the controller 800 obtains information on the relative humidity RH inside the image forming apparatus from the temperature/humidity sensor 114. In step S21, the controller 800 determines a target value of the latent image contrast Vc based on the relative humidity RH. A calculation formula for obtaining the target value of the latent image contrast Vc from the relative humidity RH is stored in advance in the controller 800, and the controller 800 can determine the target value of the latent image contrast Vc from the relative humidity RH, using that calculation formula. A configuration may be taken so as to store in advance, in the controller 800, information representing a correspondence between the relative humidity RH and the target value of the latent image contrast Vc, rather than a calculation formula. In this case, the controller 800 obtains the target value of the latent image contrast Vc from the relative humidity RH based on that information.

In step S22, the controller 800 determines the amount X of increase in exposure luminance based on the target value of the latent image contrast Vc determined in step S21. Information indicating a correspondence between the target value of the latent image contrast Vc and the amount X of increase in exposure luminance are set in advance in the controller 800, and the controller 800 determines the amount X of increase based on that information.

The controller 800 can determine the value of the reference luminance, that is, the reference value, based on the target value of the latent image contrast Vc and determine the amount of increase such that the value of the exposure luminance obtained by increasing the determined reference value by the amount of increase is within a range of exposure luminance that is possible for that amount of increase.

By determining the amount X of increase in exposure luminance as described above, it is possible to maintain reproducibility of a highlight region and a thin line that has a predetermined width or less and bring the density of a region different from a highlight region or a line that has a predetermined width or more closer to the target density.

### Third Embodiment

Next, a third embodiment will be described focusing on differences from the second embodiment. In the second embodiment, the necessary latent image contrast Vc is determined based on the environmental information, and the amount X of increase in exposure luminance is determined based on the determined latent image contrast Vc. In the present embodiment, the amount X of increase in exposure luminance is determined according to a detection result of patch images detected by the optical sensor 113. FIG. 19 is a flowchart of processing for determining the amount X of increase in exposure luminance according to the present embodiment. The processing of FIG. 19 corresponds to the processing performed in step S10 of FIG. 14 in the first embodiment.

In step S30, the controller 800 determines the charging potential Vd of the photosensitive body 102, the developing potential Vdc outputted by the developing device 108, and the amount X of thinning of the processing target dots based on the environmental information (temperature and humidity) obtained from the temperature/humidity sensor 114 based on an environment table (not illustrated). Then, in step S31, the controller 800 forms a plurality of patch images on the transfer belt 111 using respective ones of a plurality of different exposure luminances. At this time, the values determined in step S30 is used as the amount X of thinning of the processing target dots, the developing potential Vd, and the value of the charging potential Vd. In step S32, the controller 800 determines the density of each of the plurality of patch images based on the detection result of the plurality of patch images by the optical sensor 113. Then, in step S32, the controller 800 determines, based on the detected densities of the plurality of patch images and a maximum density to be a target, an exposure luminance with the maximum density as its target value. Since the patch images have been subjected to thinning processing with the amount X of thinning, the exposure luminance determined here is not the reference luminance but the exposure luminance obtained by increasing the reference luminance by the increase amount X.

In step S33, the controller 800 determines whether the exposure luminance determined in step S32 is greater than or equal to a lower limit value and less than or equal to an upper limit value of an exposure luminance for when the amount of increase is X. When the exposure luminance greater than or equal to the lower limit value and less than or equal to the upper limit value, the controller 800 sets the amount X of thinning to be the amount of increase in exposure luminance, determines the exposure luminance determined in step S32 to be the exposure luminance that has been increased, and ends the processing of FIG. 19. Meanwhile, if the exposure luminance determined in step S32 is not within a range from the lower limit value to the upper limit value for the amount X of thinning, the controller 800 adjusts the value of X by a predetermined amount and repeats the processing from step S31. If the exposure luminance is less than the lower limit value, the controller 800 increases the amount X of thinning. If the exposure luminance is greater than the upper limit value, the controller 800 decreases the amount X of thinning.

By determining the amount X of increase in exposure luminance as described above, it is possible to maintain reproducibility of a highlight region and a thin line that has a predetermined width or less and bring the density of a region different from a highlight region or a line that has a predetermined width or more closer to the target density.

In the present embodiment, patch images formed on the photosensitive body 102 are transferred to the transfer belt 111, which is another member, and the densities of the patch images are measured. However, a configuration may be taken so as to measure the densities of the patch images formed on the photosensitive body 102.

### Fourth Embodiment

Next, a fourth embodiment will be described focusing on differences from the first to third embodiments. At the end of image formation, after the voltage applied to the charging device 107 is stopped, the residual potential on the surface of the photosensitive body 102 is neutralized by the exposure head 106. The repetition of the neutralization processing decreases the light emission efficiency of the light-emitting elements 602, which may affect the life of the light-emitting elements 602. Therefore, in the present embodiment, in the neutralization processing performed after image formation, the luminance of exposure by the exposure head 106 is made to be lower than the luminance of exposure at the time of image formation.

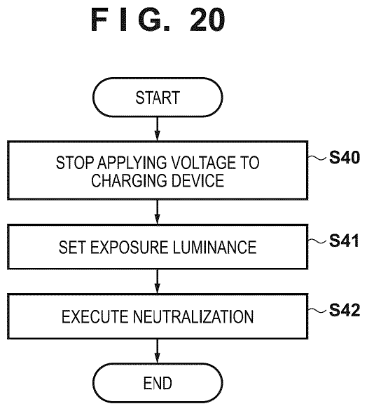

FIG. 20 is a flowchart of the present embodiment. The processing of FIG. 20 is started after the end of image formation. In step S40, the controller 800 stops applying voltage to the charging device 107. The charging device 107 thereby stops outputting charging voltage. In step S41, the controller 800 sets an exposure luminance for when performing neutralization. The exposure luminance for when performing neutralization is an exposure luminance that is lower than an exposure luminance that has been used in the immediately preceding image formation, that is, a luminance obtained by increasing the reference luminance by X %. In step S42, the controller 800 performs neutralization of the photosensitive body 102.

As described above, by making the exposure luminance at the time of neutralization lower than the exposure luminance at the time of image formation, it is possible to reduce the influence on the life of the exposure head 106 and efficiently perform neutralization.

### OTHER EMBODIMENTS

In the first to fourth embodiments, the exposure luminance is increased from the reference luminance. However, the configurations of the first embodiment to the fourth embodiment can be applied even when the exposure luminance needs to be reduced from the reference luminance. Therefore, the amount of increase in the first to fourth embodiments can be read as the amount of change. In this case, the second image data is generated by increasing or decreasing bit data indicating emission of light-emitting elements based on a ratio of the setting value to the reference value in the first region excluding the edge region within the region where bit data indicating emission of the light-emitting element 602 in the first image data is contiguous.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-015051, filed Feb. 2, 2024, which is hereby incorporated by reference herein in its entirety.

What is claimed is:

1. An image forming apparatus comprising:
a photosensitive body configured to be rotationally driven;
an exposure head configured to expose the photosensitive body, using a plurality of light-emitting elements arranged along a direction of a rotational axis of the photosensitive body;
a setting unit configured to set an exposure luminance of the photosensitive body by the plurality of light-emitting elements; and
a processing unit configured to generate first image data, which is a set of bit data for controlling emission or non-emission of the plurality of the light-emitting elements, and based on the first image data, second image data, which is obtained by increasing or decreasing light-emitting elements that emit light in the first image data, and perform processing for outputting the second image data to the exposure head,
wherein the processing unit is configured to generate the second image data by increasing or decreasing, in a first region, which excludes an edge region inside a region in which pieces of bit data indicating emission of a light-emitting element are contiguous in the first image data, bit data indicating emission of a light-emitting element, according to a ratio of a setting value of the exposure luminance set in the setting unit and a reference value of the exposure luminance.

2. The image forming apparatus according to claim 1, wherein
a number of pieces of bit data indicating emission of a light-emitting element to be increased or decreased in the first region relative to a number of pieces of bit data in the first region is based on a ratio of the setting value to the reference value.

3. The image forming apparatus according to claim 1, wherein
the processing unit is configured to perform, on the first image data, filter processing in which an edge preserving filter is used, and determine the first region based on the first image data on which the filter processing has been performed.

4. The image forming apparatus according to claim 1, further comprising:
a neutralization unit configured to neutralize the photosensitive body by exposing the photosensitive body, using the exposure head, after an end of image formation that is based on the second image data,
wherein the setting unit is configured to set the setting value of the exposure luminance for when the photosensitive body is neutralized to be lower than the setting value for when the image formation that is based on the second image data is performed.

5. The image forming apparatus according to claim 1, wherein
the reference value is a value of the exposure luminance for when a maximum density of an image to be formed by the image forming apparatus is set as a target density.

6. The image forming apparatus according to claim 1, wherein
a difference between the setting value and the reference value is a predetermined value.

7. The image forming apparatus according to claim 1, further comprising:
a determination unit configured to determine the setting value.

8. The image forming apparatus according to claim 7, wherein
the determination unit is configured to estimate a film thickness of the photosensitive body and determine the setting value based on the estimated film thickness of the photosensitive body.

9. The image forming apparatus according to claim 8, wherein
the determination unit is configured to set the setting value to be lower as the film thickness of the photosensitive body decreases.

10. The image forming apparatus according to claim 7, wherein
the determination unit is configured to set the setting value based on a relative humidity inside the image forming apparatus.

11. The image forming apparatus according to claim 10, wherein
the determination unit is configured to determine a target value of a latent image contrast based on the relative humidity and determine the setting value based on the determined target value.

12. The image forming apparatus according to claim 11, wherein
a range of the exposure luminance is limited according to an amount of change in the setting value from the reference value, and
the determination unit is configured to determine the reference value based on the target value and, by determining the amount of change such that a value of the exposure luminance obtained by changing the determined reference value by the amount of change is within a range of the exposure luminance for that amount of change, determine the setting value.

13. The image forming apparatus according to claim 7, wherein
the determination unit is configured to detect a density of a patch image formed on the photosensitive body or a patch image formed on the photosensitive body and transferred to another material, and determine the setting value based on the detected density of the patch image.

14. The image forming apparatus according to claim 13, wherein
a range of the exposure luminance is limited according to an amount of change in the setting value from the reference value, and
the determination unit is configured to determine the setting value obtained by changing the reference value by the amount of change based on the detected density of the patch image, and determine the setting value such that the amount of change at the determined setting value is within a range of the exposure luminance for that amount of change.
